(19) United States
(12) Patent Application Publication
(10) Pub. No.: US 2011/0173328 A1
(43) Pub. Date: Jul. 14, 2011

(54) ELECTRONIC DEVICE, CLOUD INSTANCE, APPARATUS, METHOD, AND SYSTEM FOR COMBINING CLOUD INSTANCES WITH RESOURCES OF DEVICES

(75) Inventors: Jae-Min PARK, Seoul (KR); Byung-Woan Kim, Seoul (KR); Kyung-Ah Chang, Seoul (KR)

(73) Assignee: SAMSUNG ELECTRONICS CO., LTD., Suwon-si (KR)

(21) Appl. No.: 12/959,006

(22) Filed: Dec. 2, 2010

(30) Foreign Application Priority Data
Jan. 13, 2010 (KR) 10-2010-0003255

(51) Int. Cl. G06F 15/173

(52) U.S. Cl. 709/226

(57) ABSTRACT

A resource distribution apparatus, method and system for combining cloud resources with resources of a plurality of devices and distributing the combined resources to the respective devices are provided. The resource distribution apparatus may include a resource management unit to register and manage a plurality of devices and a cloud instance created by a cloud resource, and a resource adjustment unit to combine the registered cloud instance with resources of the registered devices and distribute the combined resources to the respective devices.

### CROSS-REFERENCE TO RELATED APPLICATION(S)

This application claims the benefit under 35 U.S.C. §119(a) of Korean Patent Application No. 10-2010-0003255, filed on Jan. 13, 2010, in the Korean Intellectual Property Office, the entire disclosure of which is incorporated herein by reference for all purposes.

### BACKGROUND

1. Field

The following description relates to cloud computing, and more particularly, to an apparatus and method for combining cloud instances with resources of devices.

2. Description of the Related Art

Cloud computing is a type of service-based distributed computing platform. In cloud computing, a plurality of independent computing resources are moved to a cloud platform, which is an Internet platform having computing functionality, to allow users to access the Internet anywhere and anytime and use desired computing resources, and then to charge per use of computing resources. On the cloud platform, a plurality of physical and logical servers exist as resources. These are referred to as “cloud resources.” The cloud resources are connected to each other through a network.

Accordingly, cloud computing may be useful for overcoming problems which may arise when certain resources are limited. In other words, since consumer electronics or terminals, such as TVs, a mobile terminals, computers, etc., which are optimized to implement their inherent function, may have limitations in implementing any different functionality thereon, the cloud computing has been developed to overcome such limitations of resources of consumer electronics or terminals. The basic concept of cloud computing is that consumer electronics or terminals are only responsible for interaction with users or outputting execution results, whereas complicated, difficult computing for actually acquiring the execution results is performed using resources on a cloud platform. That is, a cloud platform is provided to compensate for the insufficient computing capabilities of consumer electronics or terminals.

For example, various consumer electronics, such as mobile phones, TVs, computers, etc., may be used most effectively as input/output devices, allowing actual computing to be executed using various resources existing on a cloud platform, and then outputting the results of the execution to the corresponding consumer electronics.

However, there are instances in which, in spite of the use of a cloud platform, certain complicated applications are unable to be executed due to limitations of the input/output unit of consumer electronics. For example, when a user tries to execute a high definition game using a small mobile phone, the high definition game would have to be shown on the display of the mobile phone even though it is executed using a cloud platform. Accordingly, due to the small size and limited number of pixels of the mobile phone display, the mobile phone would fail to exhibit high definition execution results obtained by use of cloud resources.

Furthermore, as the conventional scheme does not use inherent resource information of consumer electronics, there are difficulties in implementing cloud computing in accordance with the characteristics of consumer electronics having various capabilities.

### SUMMARY

In one general aspect, there is provided a resource distribution apparatus, including: a resource management unit configured to register and manage: a plurality of devices, and a cloud instance created by a cloud resource, and a resource adjustment unit configured to: combine the registered cloud instance with resources of the registered devices, and distribute the combined resources to the respective devices.

In the resource distribution apparatus, the resource adjustment unit may be further configured to: receive a request for using the plurality of devices from a user, combine the registered cloud instance with the resources of the registered devices in accordance with characteristics of the respective devices, and distribute the combined resources to the respective devices.

In the resource distribution apparatus, the resource adjustment unit may be further configured to: combine the registered cloud instance with a resource of an input unit or an output unit of each of the registered devices in accordance with characteristics of the input unit or the output unit of the device, and distribute the combined resources to the respective devices.

In the resource distribution apparatus, the resource adjustment unit may be further configured to: combine an execution result resource of a program executed on the cloud instances with an output resource of a first device among devices having been requested to be used to output the execution result of the program through an output unit of the first device, and combine an execution control resource of the program with an input resource of a second device among the devices having been requested to be used to perform the execution control of the program through an input unit of the second device.

In the resource distribution apparatus, each device may include an information terminal including: a network interface, and at least one of: an input unit and an output unit.

In another general aspect, there is provided a resource distribution method of combining a cloud resource with resources of a plurality of devices, the method including: registering and managing the plurality of devices and a cloud instance created by the cloud resource, combining the registered cloud instance with resources of the registered devices, and distributing the combined resources to the respective devices.

In the resource distribution method, the combining of the registered cloud instance with the resources of the registered devices and the distributing of the combined resources to the respective devices may include: receiving a request for using the plurality of device from a user, combining the registered cloud instance with the resources of the registered devices in accordance with characteristics of the respective devices, and distributing the combined resources to the respective devices.

In the resource distribution method, the combining of the registered cloud instance with the resources of the registered devices and the distributing of the combined resources to the respective devices may include: combining the registered cloud instance with resources of an input unit or an output unit of each of the registered devices in accordance with characteristics of the input unit or the output unit of the device, and distributing the combined resources to the respective devices.

In the resource distribution method, the combining of the registered cloud instance with the resources of the registered devices and the distributing of the combined resources to the respective devices may include: combining an execution result resource of a program executed on the cloud instances with an output resource of a first device among devices having been requested to be used to output the execution result of the program through an output unit of the first device, and combining an execution control resource of the program with an input resource of a second device among the devices having been requested to be used to perform the execution control of the program through an input unit of the second device.

In the resource distribution method, each device may include an information terminal including: a network interface, and at least one of: an input unit and an output unit.

In another general aspect, there is provided an electronic device, including: an input/output (I/O) device, an input/output (I/O) registration unit configured to register the I/O device in a resource management unit of a resource distribution apparatus, an I/O controller configured to control the I/O device in response to an instruction from the resource distribution apparatus, an input converter configured to transfer a user input received by the device to a cloud instance, and an output converter configured to transfer execution results received from the cloud instance to the I/O device.

In another general aspect, there is provided a cloud instance, including: an application program executing unit, an input converter configured to transfer a user input received from a device to the application program executing unit, an output converter configured to transfer execution results of the application program executing unit to an input/output distributor, and the input/output (I/O) distributor configured to transfer an output of the cloud instance to two more devices.

In another general aspect, there is provided a system for combining cloud instances with resources of devices, including: a resource distribution apparatus, a plurality of devices, and a plurality cloud instances, resources of at least one of the plurality of devices being combined with at least one of the plurality cloud instances at the resource distribution apparatus, the combined resources being distributed to respective devices.

A computer-readable information storage medium may store a program for implementing the resource distribution method.

Other features and aspects may be apparent from the following detailed description, the drawings, and the claims.

### BRIEF DESCRIPTION OF THE DRAWINGS

FIG. 1 is a diagram illustrating an example of a concept of a resource distribution system to combine cloud instances with resources of devices.

FIG. 2 is a diagram illustrating an example of a resource distribution system.

FIG. 3 is a diagram illustrating an example of a configuration of the resource distribution system of FIG. 2, including a resource distribution apparatus, a plurality of devices, and a cloud instance.

FIG. 4 is a diagram illustrating an example of a resource registration procedure.

FIG. 5 is a flowchart illustrating an example of a resource distribution method.

FIG. 6 is a diagram illustrating another example of a resource distribution method.

FIG. 7 is a diagram illustrating an example of an application of resource distribution.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

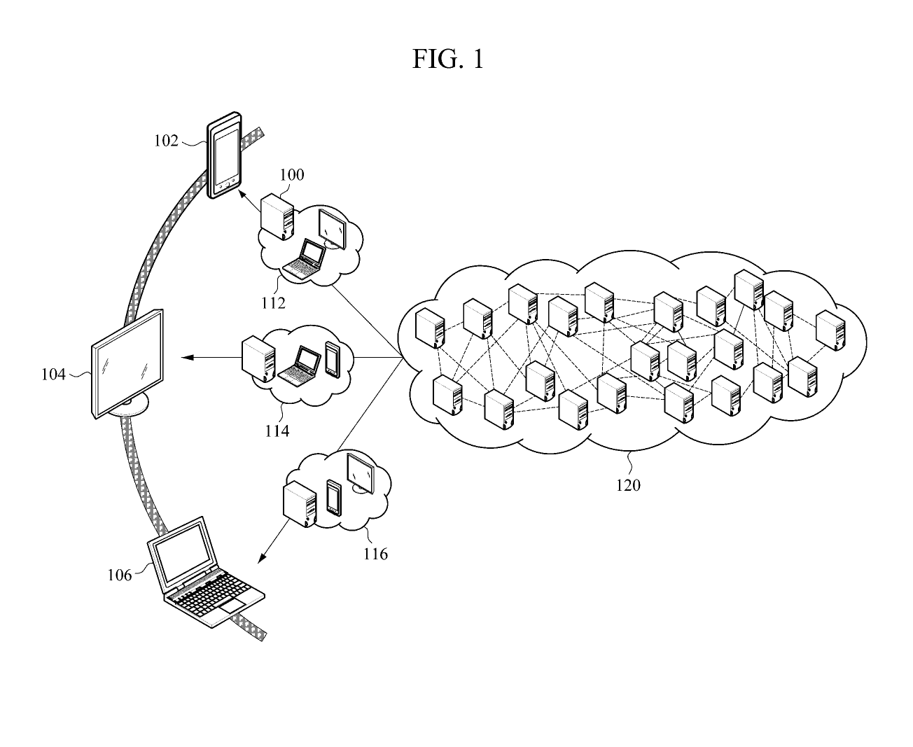

FIG. 1 illustrates an example of a concept of a resource distribution system to combine cloud instances with resources of devices.

Referring to the example in FIG. 1, cloud computing may be implemented by providing a plurality of devices (also respectively referred to as first device 102, second device 104, and third device 106) with cloud instances (also respectively referred to as first cloud instance 112, second cloud instance 114, and third cloud instance 116) that are executed and created on a cloud 120, including a plurality of servers. The first cloud instance 112, second cloud instance 114, and third cloud instance 116 are respectively specialized for the first device 102, second device 104, and third device 106.

For example, it may be presumed that cloud computing services are provided to the first device 102, for example, a mobile phone, a second device 104, for example a digital television, and a third device 106, for example a computer. Mobile phones may exhibit excellent communications performance but have limitations in data processing and display capabilities, and digital television may implement high-quality display but have low data processing and low communications capabilities. Also, computers may have excellent data processing capability but show disadvantages in respect of communications and display capabilities over mobile phones and digital televisions.

Accordingly, in one example, the first cloud instance 112 provided to the first device 102 may be a combination of resources of the second device 104 and the third device 106 with resources of the cloud 120. In other words, the first device 102 receives combined resources associated with high-quality display and high data processing capabilities that are not possessed by the first device 102, in the form of the first cloud instance 112. Likewise, the second cloud instance 114 provided to the second device 104 may be a combination of resources of the first device 102 and the third device 106 with the resources of the cloud 120, and the third cloud instance 116 provided to the third device 106 may be a combination of resources of the first device 102 and the second device 104 with the resources of the cloud 120.

Meanwhile, combining resources of different devices with resources of a cloud and distributing the combined resources to the respective corresponding devices may be performed by the resource distribution apparatus 100.

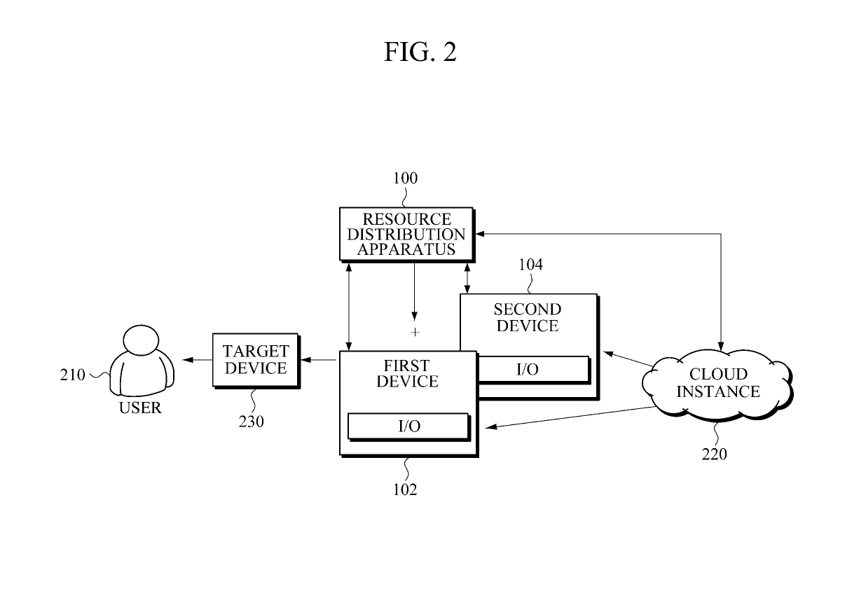

FIG. 2 illustrates an example of the resource distribution system.

Referring to the example in FIG. 2, the resource distribution apparatus 100 may combine a cloud instance 220 created on a cloud with an Input/Output (I/O) resource of the first device 102 and an I/O resource of the second device 104, and may provide the combination through a target device 230, offering a user the same effect as if directly using the first and second devices 102 and 104. That is, the first and second devices 102 and 104 which are physically separated from each other may be used by the target device 230 as if they are resources of the target device 230.

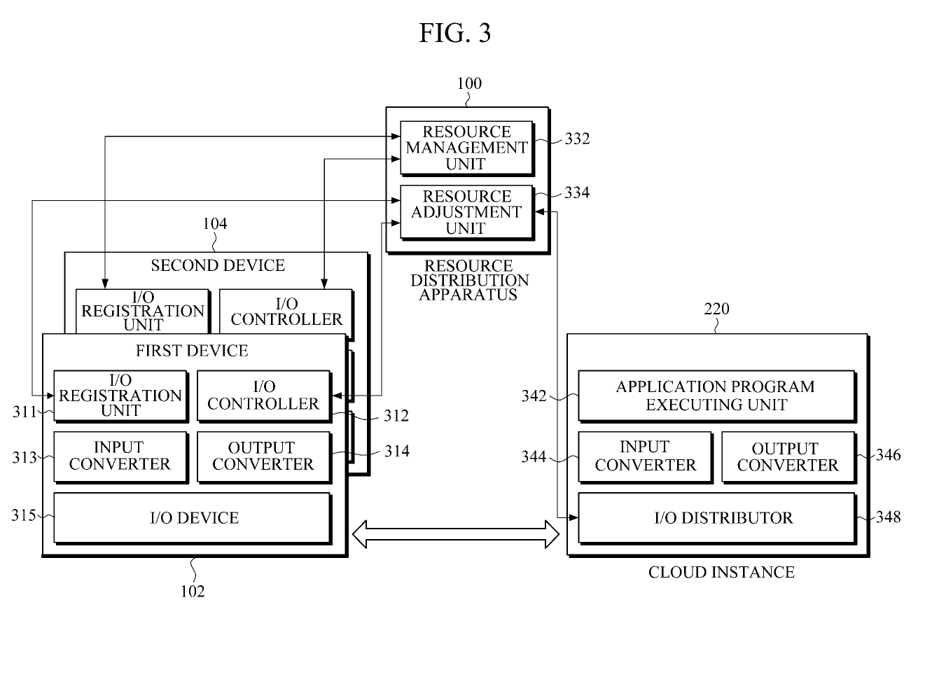

FIG. 3 illustrates an example of a configuration of the resource distribution system of FIG. 2, including a resource distribution apparatus 100, a plurality of devices, e.g., the first device 102 and the second device 104, and a cloud instance 220.

In one example, the resource distribution apparatus 100 may include a resource management unit 332 and a resource adjustment unit 334. The first device 102 and the second device 104 may each include an I/O registration unit 311, an I/O controller 312, an input converter 313, an output converter 314, and an I/O unit 315. The first device 102 and the second device 104 may be information communication terminals having an I/O unit and a network interface. Also, the cloud instance 220 may include an application program executing unit 342, an input converter 344, an output converter 346, and an I/O distributor 348.

The resource management unit 332 may register and manage the first device 102, the second device 104, and the cloud instance 220 created by a cloud resource. That is, the resource management unit 332 may register and manage the first device 102, the second device 104, the I/O units 315 of the first device 102 and the second device 104, and the cloud instance 220.

The resource adjustment unit 334 may combine the cloud instance 220 registered in the resource management unit 332 with resources of the registered first device 102 and second device 104, and may distribute the combined resources to the first device 102 and the second device 104. For example, the resource adjustment unit 334 may receive a request for using a plurality of devices from a user, may combine the registered cloud instance 220 with resources of the first device 102 and the second device 104 in consideration of the characteristics of the I/O units of the first device 102 and the second device 104, and may then distribute the combined resources to the first device 102 and the second device 104.

In other words, the resource adjustment unit 334 may combine the output resource of the first device 102 among devices that have been requested to be used with the execution result resource of a program executed by the application program executing unit 342 to output the execution result of the program through an I/O unit 315, such as an output unit of the first device 102. Then, the resource adjustment unit 334 may combine the input resource of the second device 104 among devices that have been requested to be used with an execution control resource of the program to perform the execution control of the program through an I/O unit (for example, an input unit) of the second device 104.

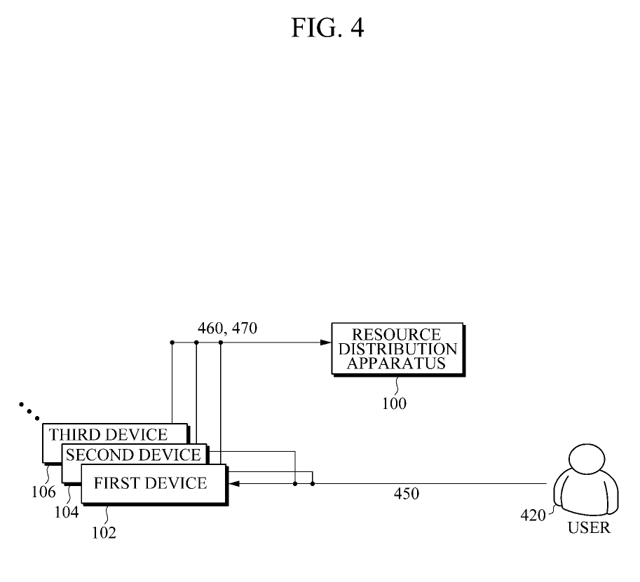

The I/O registration unit 311 may register the I/O unit 315 of the corresponding first device 102 in the resource management unit 332 of the resource distribution apparatus 100. An example of resource registration is described below with reference to FIG. 4. The I/O controller 312 may control the I/O unit 315 in response to an instruction from the resource distribution apparatus 100. For example, the I/O controller 315 may control input/output units, such as a display, a keyboard, a manipulation unit, a touchscreen, and the like, in response to an instruction from the resource distribution apparatus 100. It should be appreciated that the list is nonlimiting. The input converter 313 may transfer a user input received by the first device 102 to the application program executing unit 342 of the cloud instance 220. For example, the input converter 313 may transfer a user command received through a keyboard or a manipulation unit mounted on the first device 102 to the application program executing unit 342. The output converter 314 may transfer execution results of the application program executing unit 342 of the cloud instance 220 to the I/O unit 315 of the first device 102 such that the execution results are shown to the user through the I/O unit 315. For example, when a game is executed by the application program executing unit 342, the execution screen of the game may be shown through a monitor mounted at the first device 102 or the second device 104.

The input converter 344 of the cloud instance 220 may transfer the user input received from the first device 102 or the second device 104 to the application program executing unit 342. The output converter 346 of the cloud instance 220 may transfer the execution results by the application program executing unit 342 to the I/O distributor 348. The I/O distributor 348 may transfer the output of the cloud instance 220 to two or more devices, for example, to both the first device 102 and the second device 104.

FIG. 4 illustrates an example of a resource registration procedure.

In this example, a user 420 may first request a resource distribution apparatus 100 to register the user's devices 102, 104, and 106 and their Input/Output (I/O) resources in order to combine the devices 102, 104, and 106 with a cloud instance 450.

That is, the respective devices 102, 104, and 106 may register themselves in the resource distribution apparatus 100 on behalf of the user 420 at operation 460, and may simultaneously register their I/O resources in the resource distribution apparatus 100 at operation 470. The registration of the devices 102, 104, and 106 and their I/O resources may be performed by the corresponding I/O registration units, for example, the I/O registration unit 311 of FIG. 3.

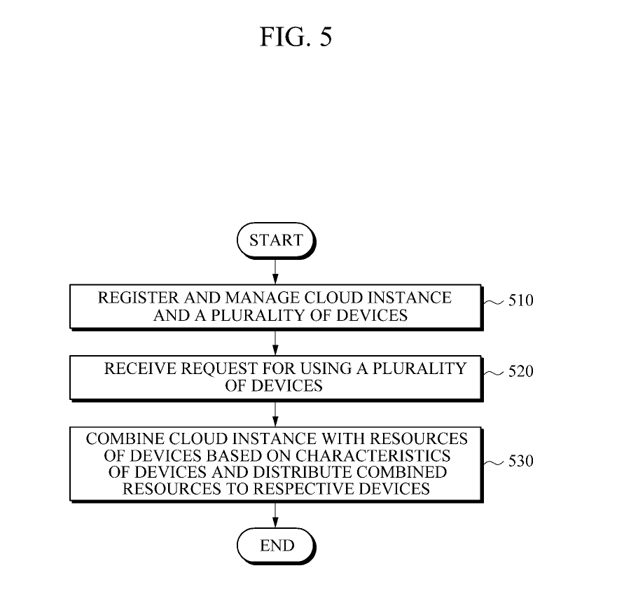

FIG. 5 illustrates an example of a resource distribution method.

In operation 510, cloud instances created by cloud resources and a plurality of devices may be registered and managed. Registration of devices and their I/O resources has been described above in detail with reference to FIG. 4.

In operations 520 and 530, the registered cloud instances may be respectively combined with resources of the registered devices and then distributed to the respective devices. That is, in response to a request for using a plurality of devices being received from a user in operation 520, a resource of each of requested devices may be combined with the cloud instances based on the characteristics of the device, and then the combined resource may be distributed to the corresponding device in operation 530. In other words, resources of devices which have been requested to be used may be combined with cloud instances based on the I/O characteristics of the devices and then the combined resources are distributed to the respective devices.

An example of a combination of a cloud instance and a device resource is to combine the execution results of a program executed on the cloud instances with an output resource of a device selected as an output device from among devices that have been requested to be used to output the combined resource through the output unit of the device. Also, the execution control resource of the program may be combined with an input resource of another device selected as an input device from among the devices that have been requested to be used such that the execution control of the program may be performed by the input unit of the device.

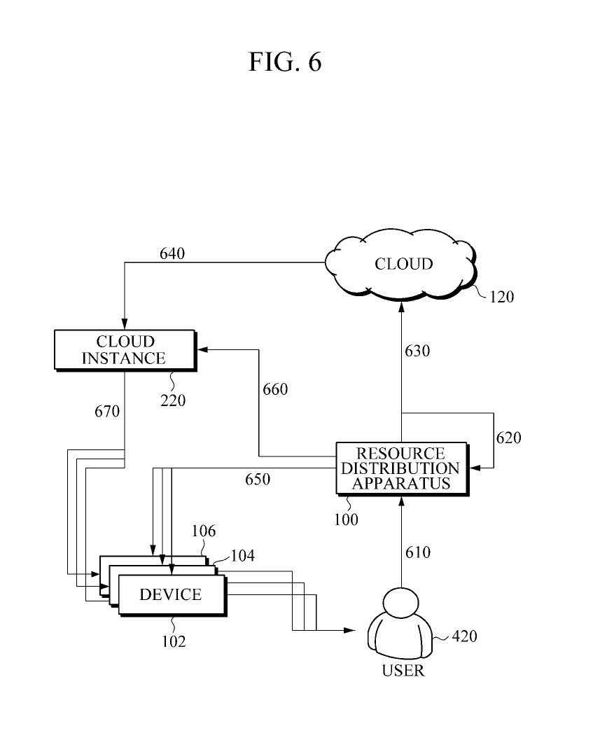

FIG. 6 illustrates another example of a resource distribution method.

In one example, a user 420 may request reception of a cloud service through devices registered in a resource distribution apparatus 100 at operation 610. At operation 620, the resource distribution apparatus 100 may search for information about a device requested by the user 420 to detect a currently available device and identify an available I/O unit included in the device. At operation 630, the resource distribution apparatus 100 may request the cloud 120 to provide a cloud instance 220 that is suitable for the detected device. At operation 640, the cloud 120 may provide the requested cloud instance 220 to the user 420 in response to the request from the resource distribution apparatus 100. At operation 650, the resource distribution apparatus 100 may set the input and output destinations of a plurality of devices 102, 104, and 106 that are to participate in the cloud service, thus controlling the input/outputs between the devices 102, 104, and 106 or between the user 420 and the devices 102, 104, and 106. At operation 660, the resource distribution apparatus 100 may request the cloud instance 220 to provide computing resources to the selected device. In response to the request from the resource distribution apparatus 100, the cloud instance 220 may provide the requested resources to the device at operation 670. In this way, the user 420 may receive the cloud service through the input/output units of the user devices 102.

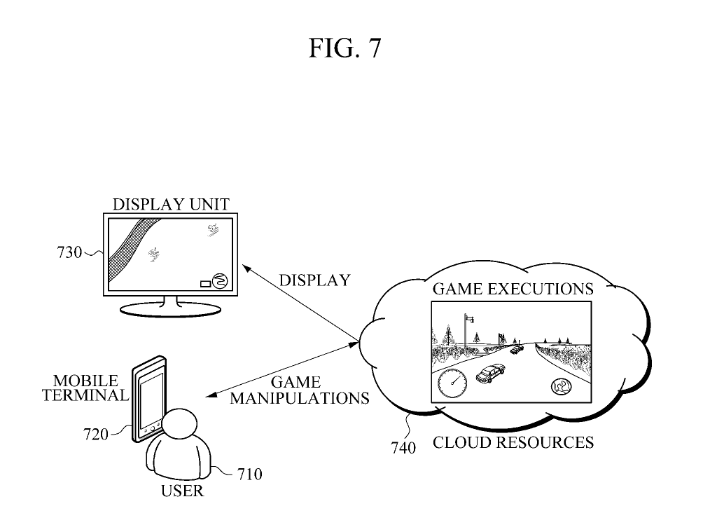

FIG. 7 illustrates an example of an application of resource distribution.

Referring to the example in FIG. 7, in this application, a mobile terminal 720, such as a mobile phone, and a display 730, such as digital TV, may be utilized such that a user may enjoy a high definition and/or three-dimensional (3D) game, for example, through the mobile terminal 720 or display 730. Generally, it is difficult for high definition and/or 3D games to be executed on a mobile terminal since they require many resources for data processing. To address this, in the example shown in the application of FIG. 7, a 3D game may be executed using a cloud resource 740, and a user 710 may receive the results of the execution through the display 730.

In other words, in response to a user 710 manipulating a game using an input device such as a keypad of a mobile terminal 720, the game may be executed using a cloud resource 740, and the results of the execution may be shown on a display 730, such as digital TV. Accordingly, the user 710 may use a cloud computing service more effectively. It should be appreciated that the mobile phone and digital TV are nonlimiting examples, only.

According to the above-described examples, as cloud computing services may be provided through combinations of various consumer electronics, users may use resources on a cloud platform more effectively. In other words, users may use a desired service more effectively in light of the characteristics of the input/output units of a plurality of consumer electronics.

Further, users may use a desired cloud service while using inherent resource information of various consumer electronics by registering them in a cloud system.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the devices described herein may refer to mobile devices such as a cellular phone, a personal digital assistant (PDA), a digital camera, a portable game console, an MP3 player, a portable/personal multimedia player (PMP), a handheld e-book, a portable laptop and/or tablet PC, a global positioning system (GPS) navigation, and devices such as a desktop PC, a high definition (HDTV), an optical disc player, a setup box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A resource distribution apparatus, comprising:
a resource management unit configured to register and manage:
a plurality of devices; and
a cloud instance created by a cloud resource; and
a resource adjustment unit configured to:
combine the registered cloud instance with resources of the registered devices; and
distribute the combined resources to the respective devices.

2. The resource distribution apparatus of claim 1, wherein the resource adjustment unit is further configured to:
receive a request for using the plurality of devices from a user;
combine the registered cloud instance with the resources of the registered devices in is accordance with characteristics of the respective devices; and
distribute the combined resources to the respective devices.

3. The resource distribution apparatus of claim 2, wherein the resource adjustment unit is further configured to:
combine the registered cloud instance with a resource of an input unit or an output unit of each of the registered devices in accordance with characteristics of the input unit or the output unit of the device; and
distribute the combined resources to the respective devices.

4. The resource distribution apparatus of claim 2, wherein the resource adjustment unit is further configured to:
combine an execution result resource of a program executed on the cloud instances with an output resource of a first device among devices having been requested to be used to output the execution result of the program through an output unit of the first device; and
combine an execution control resource of the program with an input resource of a second device among the devices having been requested to be used to perform the execution control of the program through an input unit of the second device.

5. The resource distribution apparatus of claim 1, wherein each device comprises an information terminal comprising:
a network interface; and
at least one of: an input unit and an output unit.

6. A resource distribution method of combining a cloud resource with resources of a plurality of devices, the method comprising:
registering and managing the plurality of devices and a cloud instance created by the cloud resource;
combining the registered cloud instance with resources of the registered devices; and
distributing the combined resources to the respective devices.

7. The resource distribution method of claim 6, wherein the combining of the registered cloud instance with the resources of the registered devices and the distributing of the combined resources to the respective devices comprises:
receiving a request for using the plurality of device from a user;
combining the registered cloud instance with the resources of the registered devices in accordance with characteristics of the respective devices; and
distributing the combined resources to the respective devices.

8. The resource distribution method of claim 7, wherein the combining of the registered cloud instance with the resources of the registered devices and the distributing of the combined resources to the respective devices comprises:
combining the registered cloud instance with resources of an input unit or an output unit of each of the registered devices in accordance with characteristics of the input unit or the output unit of the device; and
distributing the combined resources to the respective devices.

9. The resource distribution method of claim 7, wherein the combining of the registered cloud instance with the resources of the registered devices and the distributing of the combined resources to the respective devices comprises:
combining an execution result resource of a program executed on the cloud instances with an output resource of a first device among devices having been requested to be used to output the execution result of the program through an output unit of the first device; and
combining an execution control resource of the program with an input resource of a second device among the devices having been requested to be used to perform the execution control of the program through an input unit of the second device.

10. The resource distribution method of claim 6, wherein each device comprises an information terminal comprising:
a network interface; and
at least one of: an input unit and an output unit.

11. An electronic device, comprising:
an input/output (I/O) device;
an input/output (I/O) registration unit configured to register the I/O device in a resource management unit of a resource distribution apparatus;
an I/O controller configured to control the I/O device in response to an instruction from the resource distribution apparatus;
an input converter configured to transfer a user input received by the device to a cloud instance; and
an output converter configured to transfer execution results received from the cloud instance to the I/O device.

12. A cloud instance, comprising:
an application program executing unit;
an input converter configured to transfer a user input received from a device to the application program executing unit;
an output converter configured to transfer execution results of the application program executing unit to an input/output distributor; and
the input/output (I/O) distributor configured to transfer an output of the cloud instance to two more devices.

13. A system for combining cloud instances with resources of devices, comprising:
a resource distribution apparatus;
a plurality of devices; and
a plurality cloud instances, resources of at least one of the plurality of devices being combined with at least one of the plurality cloud instances at the resource distribution apparatus, the combined resources being distributed to respective devices.

14. A computer-readable information storage medium storing a program for implementing the resource distribution method of claim 6.
